(19) United States
(12) Patent Application Publication
(10) Pub. No.: US 2023/0289544 A1
(43) Pub. Date: Sep. 14, 2023

(54) CLIENT DEVICE FOR DISPLAYING INFORMATION FROM AN OPTICAL CODE ASSOCIATED WITH A SENSING DEVICE

(71) Applicant: ARRIS Enterprises LLC, Suwanee, GA (US)

(72) Inventor: Michael KAHN, Cherry Hill, NJ (US)

(21) Appl. No.: 18/114,400

(22) Filed: Feb. 27, 2023

Related U.S. Application Data
(60) Provisional application No. 63/317,638, filed on Mar. 8, 2022.

(51) Int. Cl. G06K 7/14

(52) U.S. Cl. CPC G06K 7/1417

(57) ABSTRACT

A client device coupled to an optical device provides for receiving from the optical device information associated with an optical code. The optical code is provided or otherwise generated by a sensing device that can be associated with a particular user, for example, a biometric sensing device associated with a aging-in-place user. The client device or a user causes the optical device to scan or otherwise obtain the information from the optical code. The client device converts the information to a format suitable for display on a display device based on one or more factors. The display of the converted information is at a size or resolution that allows a user to easily discern or otherwise read the converted information as compared to such information being displayed at the sensing device.

### BACKGROUND

Wireless in general, and Wi-Fi (wireless fidelity) in particular have become ubiquitous in networking environments such that many devices that previously relied on manual readouts and displays also provide the same information using one or more wireless technologies. Today, many devices provide information to a user, for example, biometric devices can provide needed diagnostic information for a user, such as in an Aging-in-Place environment. Typically the information is provided via a display of the device. However, such displays are typically small, have a limited display window, and/or have simple or limited resolution screens. Thus, there is a need for an improved display of information, such as information that can be obtained from an optical code generated by a device, instead of relying only the inadequate display of the device.

### SUMMARY

Generally, there are many devices in the market that a user utilizes to obtain information, such as biometric information. Each device can have a display that provides the information to a user. However, these displays are generally small with limited resolution and lack clarity. As such, information can be condensed or in a small font that impairs, impedes, or otherwise makes impossible the reading by the user, especially by a user with failing or impaired vision, such as an elderly person Aging-in-Place. According to aspects of the present disclosure there are provided novel solutions for providing information from an optical code generated by a device associated with a user to a display that is easily readable by the user. For example, many biometric devices can be used by a user that is Aging-in-Place. These devices comprise various screen or display sizes that provide the required biometric information. However, such users typically have difficult with the layout, text size, or generally use of the displays of these devices. The novel solutions presented herein provide for receiving this information via an optical code and displaying the received information to a display device selected by the user that provides the information in a format that is readable by the user, for example, in a larger font and/or increased resolution.

An aspect of the present disclosure provides a client device for receiving information associated with an optical code provided by a sensing device. The client device comprises a memory storing one or more computer-readable instructions and a processor configured to execute the one or more computer-readable instructions stored on the memory to cause the client device to receive from the optical device information associated with the optical code, convert the information to a format for display on a display device, and display the converted information the display device.

In an aspect of the present disclosure, the client device comprises the optical device, and wherein the optical device comprises a camera.

In an aspect of the present disclosure, the displaying the converted information at the display device comprises displaying the converted information at a size larger than that provided at the sensing device.

In an aspect of the present disclosure, the display device is a remote display device.

In an aspect of the present disclosure, the processor is further configured to store the converted information at a network resource.

In an aspect of the present disclosure, the optical code is associated with biometric data associated with a user of the sensing device.

In an aspect of the present disclosure, the client device comprises a remote control.

An aspect of the present disclosure provides a method by a client device to receive information associated with an optical code provided by a sensing device. The method comprises receiving from the optical device information associated with the optical code, converting the information to a format for display on a display device, and displaying the converted information at the display device.

In an aspect of the present disclosure, the method is such that the client device comprises the optical device, and wherein the optical device comprises a camera.

In an aspect of the present disclosure, the method is such that displaying the converted information at the display device comprises displaying the converted information at a size larger than that provided at the sensing device.

In an aspect of the present disclosure, the method is such that the display device is a remote display device.

In an aspect of the present disclosure, the method further comprises storing the converted information at a network resource.

In an aspect of the present disclosure, the method is such that the optical code is associated with biometric data associated with a user of the sensing device.

In an aspect of the present disclosure, the method is such that the client device comprises a remote control.

An aspect of the present disclosure provides a non-transitory computer-readable medium of a client device storing one or more instructions for receiving information associated with an optical code provided by a sensing device. The one or more instructions when executed by a processor of the client device, cause the client device to perform one or more operations including the steps of the methods described above.

Thus, according to various aspects of the present disclosure described herein, it is possible to provide information from an optical code associated with a sensing device at a display device that allows for ease of viewing, for example, the information associated with a user of a sensing data is displayed at an enlarged font size than that permitted at the sensing device. In this way, information provided without the need for additional physical interfaces, such as universal serial bus (USB) interface. The user experience is enhanced as the user can easily read the information without requiring complex conversion or transfer of the information.

### BRIEF DESCRIPTION OF DRAWINGS

In the drawings, like reference numbers generally indicate identical, functionally similar, and/or structurally similar elements.

FIG. 1 is a schematic diagram of a network environment, according to one or more aspects of the present disclosure;

FIG. 2 is a more detailed block diagram illustrating various components of a client device, according to one or more aspects of the present disclosure;

FIG. 3A is an illustration of a client device in an environment for receiving information via an optical code, according to one or more aspects of the present disclosure;

FIG. 3B is an illustration of a client device in an environment for receiving information via an optical code, according to one or more aspects of the present disclosure;

FIG. 4 is an illustration of a client device for receiving information from an optical code, according to one or more aspects of the present disclosure;

FIG. 5 is an illustration of a remote control for receiving information from an optical code, according to one or more aspects of the present disclosure; and

FIG. 6 is a flow chart illustrating a method for a client device to receive information associated with an optical code for sending to a display device, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

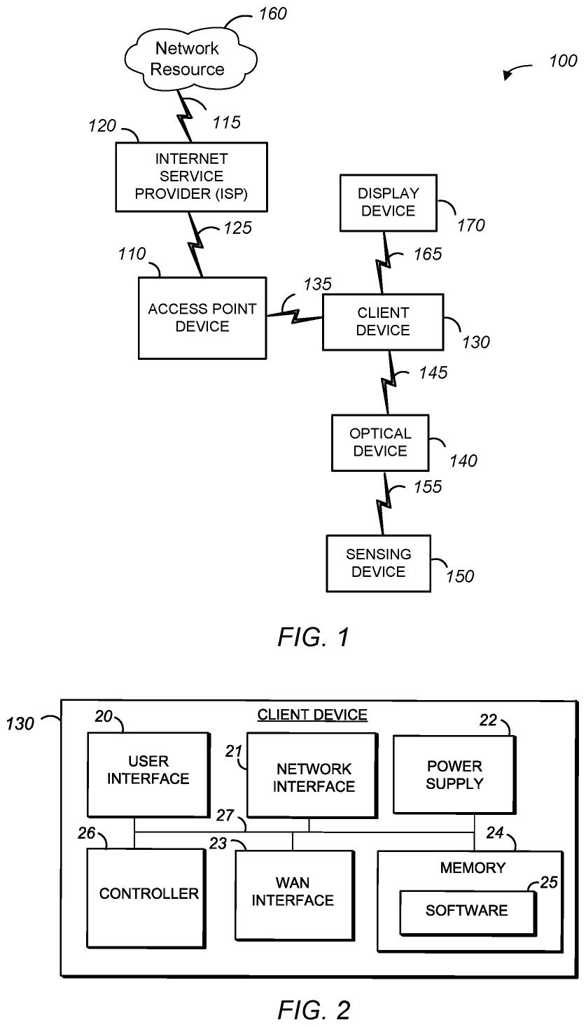

FIG. 1 is a schematic diagram of a network environment 100, according to one or more aspects of the present disclosure. For example, a wireless fidelity (Wi-Fi) network can provide for the presentation of information on a display device so as to provide a user with an enhanced experience when using a sensing device. An example network environment can be related to a caregiving network for a user (a patient) such that information associated with the user (for example, biometric data) can displayed on an easily readable display device.

It should be appreciated that various example embodiments of inventive concepts disclosed herein are not limited to specific numbers or combinations of devices, and there may be one or multiple of some of the aforementioned electronic apparatuses in the network environment, which may itself consist of multiple communication networks and various known or future developed wireless connectivity technologies, protocols, devices, and the like.

The network environment 100 includes a network comprising an access point device 110 connected to a network resource 160 via an Internet Service Provider (ISP) 120 and also connected to one or more network devices such as a client device 130 and a display device 170, an optical device 140, and a sensing device 150 via the client device 130. The network environment 100 shown in FIG. 1 includes one or more devices that may be connected in one or more wireless networks (for example, private, guest, iControl, backhaul network, or Internet of things (IoT) network) within the network environment 100. Additionally, there could be some overlap between wireless devices in the different networks. That is, one or more network or wireless devices could be located in more than one network.

ISP 120 can be, for example, a content provider or any computer for connecting the access point device 110 to a network resource 160. For example, network resource 160 can be a cloud-based service that provides access to a cloud-based repository accessible via ISP 120 where the cloud-based repository comprises information associated with or an access requested by any one or more devices of the network environment 100. The client device 130 can provide monitoring, aggregation and/or controlling of information associated with a user in the network environment 100, such as information collected by an optical device 140 by scanning an optical code generated by a sensing device 150 and can send that information via the access point device 110 and the ISP 120 to a network resource 160 for storage. The connection 115 between the network resource 160 and the ISP 120, the connection 125 between the access point device 110 and the ISP 120, the connection 135 between the access point device 110 and the client device 130, and the connections 165, 145, and 155 between the client device 130 and the display device 170, the optical device 140 and the sensing device 150, respectively, can be implemented using a wide area network (WAN), a virtual private network (VPN), metropolitan area networks (MANs), system area networks (SANs), a data over cable service interface specification (DOCSIS) network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a cellular/mobile network such as a 2G, 3G, 4G, 5G, or 6G network, for example.

Any of the connections 115, 125, 135, 145, 155 and 165, or any combination thereof (collectively referred to as network connections or connections) can further include as some portion thereof a broadband mobile phone network connection, an optical network connection, or other similar connections. For example, any of the network connections can also be implemented using a fixed wireless connection that operates in accordance with, but is not limited to, 3rd Generation Partnership Project (3GPP) Long Term Evolution (LTE), 5G, or 6G protocols. It is also contemplated by the present disclosure that any of the network connections are capable of providing connections between a network device and a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G, 5G or 6G network, for example. Further, any of the connections 135, 145, 155 and 165 can be implemented using a wireless connection in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz bands, or 60 GHz bands. Additionally, any of the connections can be implemented using a wireless connection that operates in accordance with, but is not limited to, RF4CE protocol, ZigBee protocol, Z-Wave protocol, or IEEE 802.15.4 protocol. It is also contemplated by the present disclosure that the connections can include connections to a media over coax (MoCA) network. One or more of the connections can also be a wired Ethernet connection. Any one or more of connections can carry information on any of one or more channels that are available for use.

The access point device 110 can be, for example, an access point and/or a hardware electronic device that may be a combination modem and gateway that combines the functions of a modem, an access point (AP), and/or a router for providing content received from the ISP 120 to one or more devices (for example, one or more client devices 130) in the network environment 100 and/or sending information received from the client device 130 to a network resource 160. It is also contemplated by the present disclosure that the access point device 110 can include the function of, but is not limited to, a universal plug and play (UPnP) simple network management protocol (SNMP), an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The access point device 110 may also be referred to as a residential gateway, a home network gateway, or a wireless access point (AP).

The client device 130 can be, for example, hand-held computing devices, personal computers, electronic tablets, mobile phones, smart phones, smart speakers, Internet-of-Things (IoT) devices, iControl devices, portable music players with smart capabilities capable of connecting to the Internet, cellular networks, and interconnecting with other devices via Wi-Fi and Bluetooth, or other wireless hand-held consumer electronic devices capable of executing and displaying information received through the access point device 110 and/or one or more optical devices 140 and displaying that information on a display device 170. Additionally, the client device 130 can be a television (TV), an IP/QAM set-top box (STB) or a streaming media decoder (SMD). The client device 130 can comprise any network device associated with a user for interacting with any type of one or more sensing devices 5. For example, the client device 130 can use an optical device 140 to scan an optical code generated or otherwise provided by a sensing device 150. In one or more embodiments, the optical device 140, one or more sensing devices 150, and/or display device 170 are included within or local to (built-in) the client device 130.

The display device 170 can comprise any of a computer monitor, a television screen, an e-ink display, an e-paper display, any other type of display device, or any combination thereof. An advantage to an e-ink display or an e-paper display is that such displays can provide the information obtained from an optical code even while powered-off. The display device 170 provides a display that is suitable for rendering the information from the optical code at a size or resolution that facilities the visualization of the information, for example, at a font size that is easy for an aging-in-place, an elderly person, a sight-impaired person, or any other user to read or otherwise visually discern.

One or more sensing devices 150 can connect to one or more client devices 130, and/or an optical device 140. The one or more sensing device 150 can comprise any of a biometric sensor (such as a heart monitor, a blood pressure monitor, a thermometer, etc.), a biometric tracker, an environmental sensor (such as an ambient temperature sensor, a light or photoelectric sensor, a humidity sensor, a motion detector (for example, an infrared motion sensor or Wi-Fi motion sensor, etc.), etc.), or any combination thereof. The optical device 140 can comprise an optical instrument, such as any of a camera, an image capture device, or any other visual user interface device, any device for capturing an image, a video, a multi-media video, an optical code, or any other type of data from a sensing device 150, or any combination thereof.

It is contemplated by the present disclosure that the access point device 110, the client device 130, the display device 170, the optical device 140, and the sensing device 150 include electronic components or electronic computing devices operable to receive, transmit, process, store, and/or manage data and information associated with the network environment 100, which encompasses any suitable processing device adapted to perform computing tasks consistent with the execution of computer-readable instructions stored in a memory or a computer-readable recording medium (for example, a non-transitory computer-readable medium).

FIG. 2 is a more detailed block diagram illustrating various components of an exemplary client device 130, according to one or more aspects of the present disclosure. The client device 130 comprises one or more internal components, such as a user interface 20, a network interface 21, a power supply 22, a controller 26, a WAN interface 23, a memory 24, and a bus 27 interconnecting the one or more elements.

The power supply 22 supplies power to the one or more internal components of the client device 130 through the internal bus 27. The power supply 22 can be a self-contained power source such as a battery pack with an interface to be powered through an electrical charger connected to an outlet (for example, either directly or by way of another device). The power supply 22 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The user interface 20 includes, but is not limited to, push buttons, a keyboard, a keypad, a liquid crystal display (LCD), a thin film transistor (TFT), a light-emitting diode (LED), a high definition (HD) or other similar display device including a display device having touch screen capabilities so as to allow interaction between a user and the client device 130, for example, for a user to initiate scanning by an optical device 140 of an optical code associated with a sensing device 150 to obtain information that can be stored in memory 24. The network interface 20 can include, but is not limited to, various network cards, interfaces, and circuitry implemented in software and/or hardware to enable communications with and/or between any of the access point device 110, a display device 170, an optical device 140, a sensing device 150, or any combination thereof and the client device 130 using any one or more of the communication protocols in accordance with any one or more connections (for example, as described with reference to FIG. 1). In one or more embodiments, the user interface 20 enables communications with a sensing device 150, directly or indirectly.

The memory 24 includes a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), an optical storage system, a hard disk or any other various layers of memory hierarchy. The memory 24 can be used to store any type of instructions, software, or algorithms including software 25, for example, an application for causing an optical device 140 to scan an optical code of a sensing device 150 and for displaying the information received from the optical code on a display device 170, in accordance with one or more embodiments. The memory 24 can store the information for use by the client device 130 or sending to a network resource 160.

The controller 26 controls the general operations of the client device 130 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 25 which can include an application in accordance with one or more embodiments. Communication between the components (for example, 20-26) of the client device 130 may be established using an internal bus 27.

The network interface 21 can include various network cards, interfaces, and circuitry implemented in software and/or hardware to enable communications with any one or more other devices, for example, any of an ISP 120, any other device (for example, as described with reference to FIG. 1), or any combination thereof.

The wide area network (WAN) interface 23 may include various network cards, and circuitry implemented in software and/or hardware to enable communications between devices and the ISP 120 using the wired and/or wireless protocols in accordance with connections as described with reference to FIG. 1.

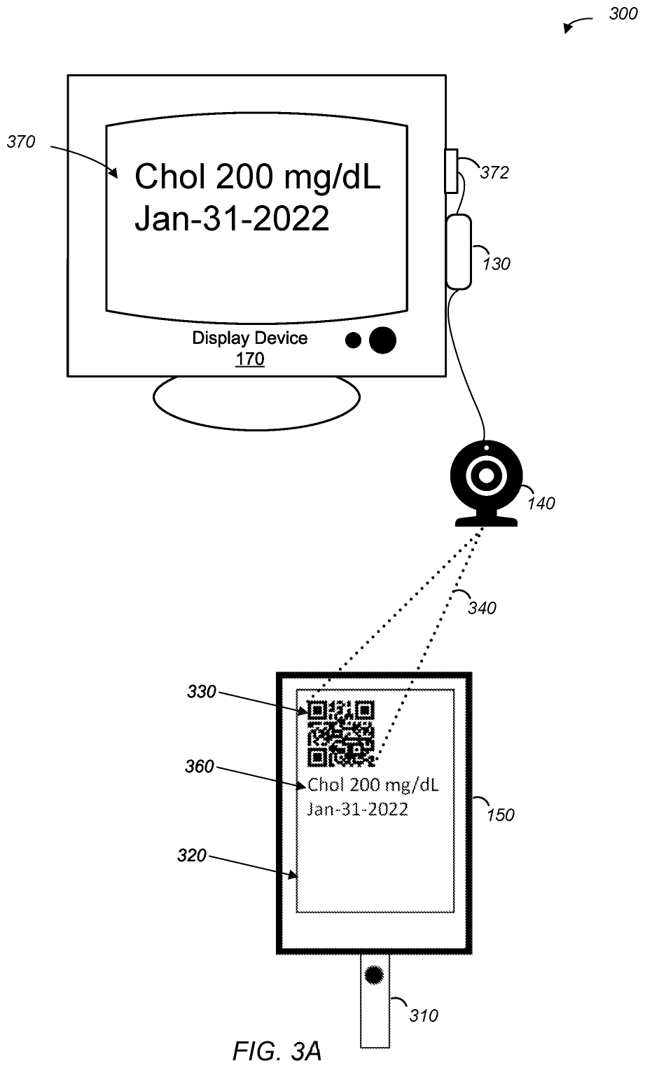

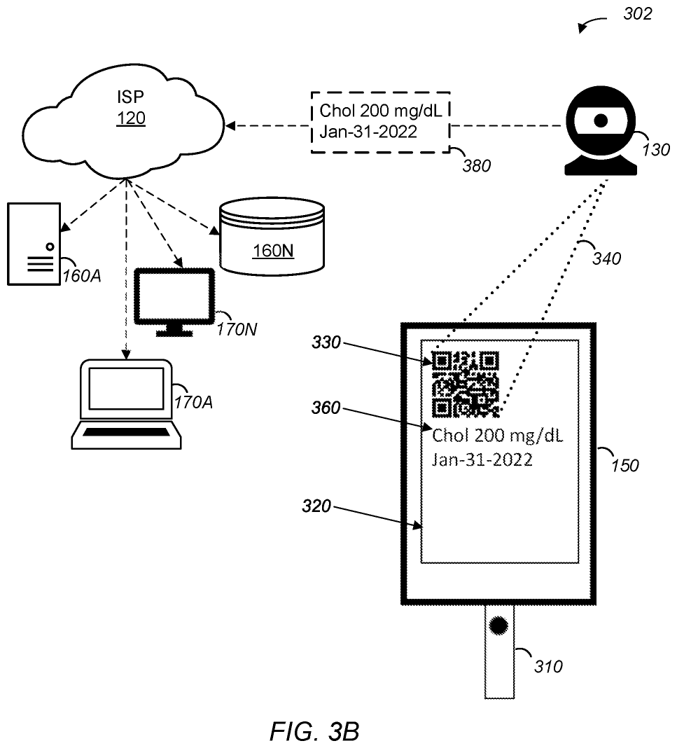

FIG. 3A illustrates a client device 130 in an environment 300 for receiving information via an optical code, according to one or more aspects of the present disclosure. The environment 300 comprises a display device 170, an optical device 140, and a sensing device 150. The display device 170 can comprise, for example, a television that comprises an interface port 372 for connecting to the client device 130. The display device 170 comprises a screen 370 that can display data such as information received from the client device 130 including, but not limited to, any of an image, a text, a video, a photograph, any other data that can be displayed on a screen 370, or any combination thereof. For example, the display device 170 can display information associated with an optical code.

The client device 130 can be connected to an optical device 140, such as a camera. The optical device 140 can be connected directly and/or indirectly, wired and/or wirelessly to the client device 130. In one or more embodiments, the optical device 140 can be included within or as part of the display device 170 or the client device 130. The optical device 140 can be used to scan an optical code 330 from a sensing device 150. For example, sensing device 150 can comprise a display 320 that displays data 360 sensed by the sensing device 150, for example, from an input 310, such as a blood test strip. The data 360 can also be encoded in an optical code 330, such as a quick response (QR) code. The client device 130 send an instruction to the optical device 140 to cause the optical device 140 to perform a scan of the optical code 330. The optical device 140 can receive information 340 from scanning the optical code 330. For example, the information 340 can comprise any of the data 360 displayed on the display 320 of the sensing device 150, data sensed by the sensing device 150 (such as a cholesterol level), data associated with the sensing device 150 (such as any of a model, a make, a type, a device identifier (for example, any of a service number, a manufacturer identifier, a unique identifier, a metadata, any other data, or any combination thereof), a user identifier (for example, a user associated with the sensing device 150), a timestamp, any other data, or any combination thereof.

FIG. 3B is an illustration of a client device 130 in an environment 302 for receiving information 340 via an optical code 330, according to one or more aspects of the present disclosure. Client device 130 in FIG. 3A comprises an optical device 140. However, in one or more embodiments, FIG. 3B can comprise the same or similar devices, including client device 130 and optical device 140, as discussed with reference to FIG. 3A. Client device 140 can send one or more data packets 380 to the ISP 120. The one or more data packets 380 can comprise the information 340 received or otherwise determined from the optical code 330. The ISP 120 can send the one or more data packets 380 to one or more network resources 160, such as any of a server 160A, a database 160N, any other repository, or any combination thereof, one or more additional display devices 170, such as any of a laptop 170A, an IoT device 170N, any other display or computer system, or any combination thereof, one or more other device, or any combination thereof. In this way, the information 340 can be received by one or more users (for example, via a conference or video-chat, an e-mail, etc.), such as a healthcare provider, a caregiver, and/or stored for later use or display at one or more devices.

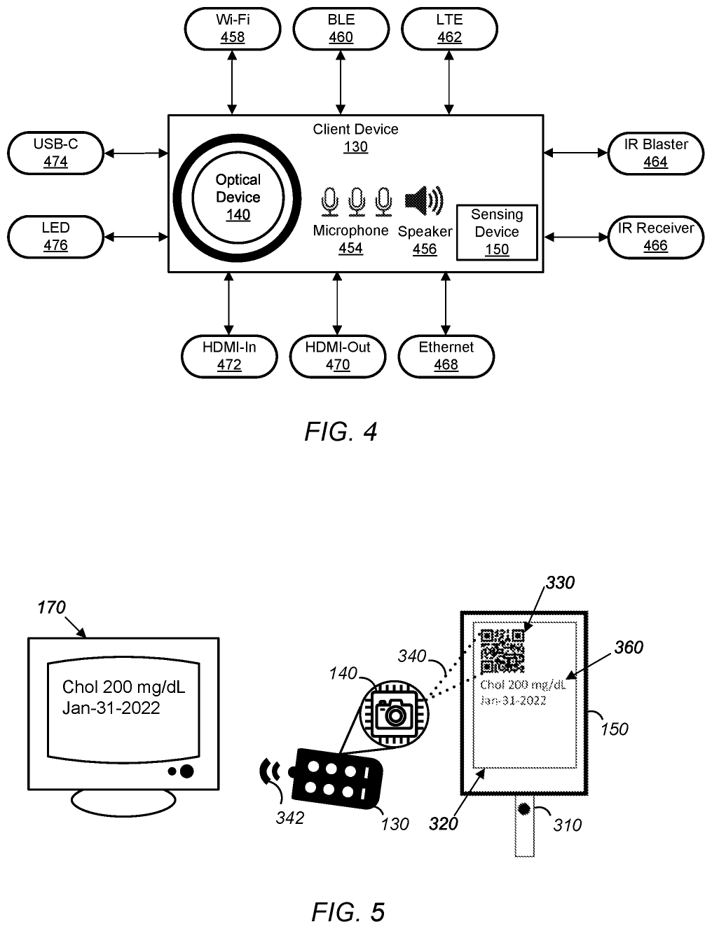

FIG. 4 is an illustration of a client device 130 for receiving information from an optical code, according to one or more aspects of the present disclosure. The client device 130 can comprise any of an optical device 140 (such as a camera or any other device that can scan an optical code), an audio input device 454 (such as a microphone, a microphone array, a far field voice (FFV) solution, etc.), an audio output device 456 (such as a speaker), a sensing device 150, or any combination thereof. In one or more embodiments, any one or more components of the client device 130 can be external to the client device 130, for example, as illustrated in FIG. 1. The client device 130 can comprise one or more ports or receivers, for example, a Wi-Fi (such as a Wi-Fi5 (dual band simultaneous (DBS))) port 458, a BLE port 460, an LTE port 462, an infrared (IR) blaster port 464, an IR receiver port 466, an Ethernet port 468, a high-definition multimedia interface (HDMI)-Out port 470, an HDMI-In port 472, an external power supply (such as a universal serial bus type-C (USB-C), an LED output 476, or any combination thereof. A sensing device 150 can comprise any one or more types of sensors such as any of a power sensor, a temperature sensor, a light sensor, a humidity sensor, a motion sensor, a biometric sensor (such as a blood pressure monitor, oxygen saturation meter, pulse meter, etc.), any other type of sensor, or any combination thereof. In one or more embodiments, the sensing device 150 can be an IoT device. The client device 130 can provide to a display device 170 via an HDMI-Out 470 information received from an optical code scanned by the optical device 140, for example, as discussed with reference to FIGS. 3A and 3B.

FIG. 5 is an illustration of a client device 130, such as a remote control, for receiving information 340 from an optical code 330, according to one or more aspects of the present disclosure. The remote control, labeled as 130 in FIG. 5, can comprise an optical device 140, such as a camera. A user can direct the optical device 140 at an optical code 330, such as a QR code, so as to scan the optical code 330 so as to receive information 340 as discussed with reference to FIGS. 3A and 3B. The remote control can then transmit the information 340 via an IR and/or RF transmission 342 to a display device 170, for example a television.

In one or more embodiments, the remote control or client device 130 of FIG. 5 can obtain data from the sensing device 150. For example, the remote control or client device 130 can send an instruction to the sensing device 150 to begin a sensing or a user can initiate a sensing of one or more parameters (for example, one or more parameters associated with a biometric sensor). The data can comprise alphanumeric data that the sensing device 130 converts to an optical code. The optical code can be rendered by the client device on a display device 170, for example, an B-link display. The optical code 330 can represent the data sensed from the biometric sensor.

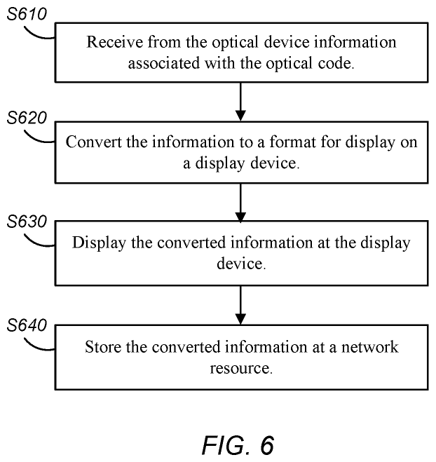

FIG. 6 is a flow chart illustrating a method for a client device 130 to receive information associated with an optical code 330 for sending to a display device 170, according to one or more aspects of the present disclosure.

The client device 130 can be programmed with one or more instructions such as an application that when executed by a processor or controller causes the client device 130 to instruct an optical device 140 to scan an optical code 330 generated or otherwise provided by a sensing device 150 according to one or more embodiments. In FIG. 6, it is assumed that any one or more of the devices, such as a client device 130, an optical device 140, a sensing device 150, and/or a display device 170 include their respective controllers and their respective software stored in their respective memories, as discussed above in connection with FIGS. 1-5, which when executed by their respective controllers perform the functions and operations in accordance with the example embodiments of the present disclosure.

The client device 130 comprises a controller 26 that executes one or more computer-readable instructions, stored on a memory 24, that when executed perform one or more of the operations of steps S610-S640. The client device 130 can comprise one or more software 25, for example, to provide information received from an optical code 330 associated with a sensing device 150 to a display device 170. While the steps S610-S640 are presented in a certain order, the present disclosure contemplates that any one or more steps can be performed simultaneously, substantially simultaneously, repeatedly, in any order or not at all (omitted). In one or more embodiments, the client device can comprise any of a remote control, a set-top box, a computing system (such as any of a laptop, a smartphone, a tablet, computer, any other computing system, or any combination thereof), an IoT device, or any combination thereof.

At step S610, the client device 130 receives from an optical device 170 information associated with an optical code 330. The optical code 330 can be provided otherwise generated by a sensing device 150. The optical device 170 can be communicatively coupled to the client device 130, for example, via any of a Wi-Fi connection, a BLE connection, an IR connection, an RF connection, any other wireless connection, or any combination thereof, connected via a wired connection to the client device 130, connected to the client device 130 via any other connection, or any combination thereof. For example, the client device 130 can send an instruction to the optical device 140 that causes the optical device 140 to scan an optical code 330 associated with a sensing device 150. As another example, a user can activate the optical device 140 to cause the optical device 140 to initiate a scan of an optical code 330 associated with a sensing device 150. The optical device 140 can then automatically or based on a user input send the information associated with the optical code 330 to the client device 130. The optical device 140 can comprise a camera or any other optical instrument that can scan or otherwise obtain information from an optical code. For example, the optical code 330 can be associated with biometric data associated with a user of the sensing device 150 as discussed with reference to FIGS. 3A and 3B.

At step S620, the client device 130 can convert the information received from the optical device 140 to a format for display on a display device 170. The display device 170 can be any of communicatively coupled, wired and/or wirelessly coupled, directly and/or indirectly coupled, or any combination thereof to the client device 130. The display device 170 can be local to or remote from the client device 130. For example, the display device 170 can be connected to the client device 130 via an ISP 120. In one or more embodiments, the display device 170 is included within or as part of the client device 130. The client device 130 can convert the information based on one or more factors. The one or more factors can comprise any of the type of optical code, data associated with the sensing device 150, type of display device 170, or any combination thereof. In one or more embodiments, the information is encrypted such that converting the information requires decrypting the information.

At step S630, the client device 130 can display the converted information at the display device 170. In one or more embodiments, the information is displayed at the sensing device 150, for example, at a first font size. The displaying at the display device 170 by the client device 130 can comprise displaying the converted information at a size larger than that provided at the sensing device 150, for example, a second font size where the points of the second font size is greater than the points of the first font size.

At step S640, the client device 130 can store the converted information at a network resource 160. For example, the network resource 160 can comprise any of a flat file system, a database, a server, a memory, any other storage medium, or any combination thereof.

One or more novel solutions provide the advantages of an easy-to-use technique to display, read/view, and/or share information associated with a user of a sensing device, for example, a small, hand-held biometric device, and display the information on a large display device, such as a television/monitor, without the need for any wireless configuration, device pairing, and/or connecting of cables. In this way, usability of such sensing devices is improved, especially for users who are visually impaired.

While the present disclosure discusses an aging-in-place environment that allows a user to send information obtained from an optical code of a sensing device to a device that provides for a larger display of the information than that of the sensing device, the present disclosure contemplates any other environment that requires the display of information associated with an optical code.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A client device for receiving information associated with an optical code provided by a sensing device, the client device comprising:
a memory; and
a processor configured to execute one or more instructions stored on the memory to cause the client device to:
receive, from an optical device, information associated with the optical code;
convert the information to a format for display on a display device; and
display the converted information at the display device.

2. The client device of claim 1, wherein the client device comprises the optical device, and wherein the optical device comprises a camera.

3. The client device of claim 2, wherein displaying the converted information at the display device comprises displaying the converted information at a size larger than that provided at the sensing device.

4. The client device of claim 1, wherein the display device is a remote display device.

5. The client device of claim 1, wherein the processor is further configured to execute the one or more instructions to further cause the client device to:
store the converted information at a network resource.

6. The client device of claim 1, wherein the optical code is associated with biometric data associated with a user of the sensing device.

7. The client device of claim 1, wherein the client device comprises a remote control.

8. A method by a client device to receive information associated with an optical code provided by a sensing device, the method comprising:
receiving from, an optical device, information associated with the optical code;
converting the information to a format for display on a display device; and
displaying the converted information at the display device.

9. The method of claim 8, wherein the client device comprises the optical device, and wherein the optical device comprises a camera.

10. The method of claim 9, wherein displaying the converted information at the display device comprises displaying the converted information at a size larger than that provided at the sensing device.

11. The method of claim 8, wherein the display device is a remote display device.

12. The method of claim 8, further comprising storing the converted information at a network resource.

13. The method of claim 8, wherein the optical code is associated with biometric data associated with a user of the sensing device.

14. The method of claim 8, wherein the client device comprises a remote control.

15. A non-transitory, computer-readable medium of a client device storing one or more computer-readable instructions for receiving information associated with an optical code provided by a sensing device, that when executed by a processor, cause the processor to perform one or more operations comprising:
receiving, from an optical device, information associated with the optical code;
converting the information to a format for display on a display device; and
displaying the converted information at the display device.

16. The non-transitory, computer-readable medium of claim 15, wherein the client device comprises the optical device, and wherein the optical device comprises a camera.

17. The non-transitory, computer-readable medium of claim 16, wherein displaying the converted information at the display device comprises displaying the converted information at a size larger than that provided at the sensing device.

18. The non-transitory, computer-readable media of claim 15, wherein the one or more computer-readable instructions when executed by the processor, further cause the processor to perform the one or more operations further comprising:
storing the converted information at a network resource

19. The non-transitory computer-readable media of claim 15, wherein the optical code is associated with biometric data associated with a user of the sensing device.

20. The non-transitory computer-readable media of claim 15, wherein at least one of:
the display device is a remote display device; and
the client device comprises a remote control.
